(19) United States
(12) Patent Application Publication
(10) Pub. No.: US 2009/0080847 A1
(43) Pub. Date: Mar. 26, 2009

(54) OPTICAL WAVEGUIDE AND METHOD FOR MANUFACTURING THE SAME

(76) Inventors: Mingda SHAO, Suzhou Industrial Park (CN); Guoqing Yu, Suzhou Industrial Park (CN); Qinqin Xu, Suzhou Industrial Park (CN); Wenlong Wang, Suzhou Industrial Park (CN); Wei Wang, Suzhou Industrial Park (CN)

Correspondence Address: FROMMER LAWRENCE & HAUG, 745 FIFTH AVENUE- 10TH FL., NEW YORK, NY, 10151, US

(21) Appl. No.: 12/271,295

(22) Filed: Nov. 14, 2008

Related U.S. Application Data
(62) Division of application No. 12/019,693, filed on Jan. 25, 2008.

(30) Foreign Application Priority Data
Sep. 25, 2007 (CN) CN200710151335.3

(51) Int. Cl. G02B 6/02

(52) U.S. Cl. 385/126; 427/163.2

(57) ABSTRACT

The present invention provides a wafer level optical waveguide and a method for manufacturing the same, wherein it can be realized by employing manufacture process for semiconductor integrated circuits to manufacture a micron optical waveguide with a smooth interface, uniform thickness and a mirror-like end with any angle, and to remarkably reduce its manufacture cost at the meantime.

### CROSS REFERENCE TO RELATED APPLICATION

This application is a division of U.S. patent application Ser. No. 12/019,693 filed Jan. 25, 2008 entitled “Optical Waveguide and Method for Manufacturing the Same” which claims priority to Chinese Patent Application Number CN200710151335.3 filed Sep. 25, 2007, the disclosures of which are incorporated herein by reference.

### FIELD OF INVENTION

The present invention relates to optoelectronic communication field, in particular to a wafer level optical waveguide and a method for manufacturing the same.

### BACKGROUND OF THE INVENTION

With the rapid development of network communication technology, high bandwidth communication is required in a number of areas of application. However, in terms of conventional electrical interconnection, which is based on electronic signal transmission line with copper as a medium, the associated bandwidth is approaching saturation. To deal with this issue, an optical communication based on optical interconnection has been developed. The optical interconnection is a technology using light as vehicle for signal propagation to establish an interconnection among parts or systems of a computer system structure. In view of transmission media used for optical interconnection, the optical interconnection mainly comprise optical waveguide-based interconnection, optical fiber-based interconnection, free space light interconnection, etc. In view of the level in a computer system structure where the optical interconnection is used, the optical interconnection can be established in different level, such as between computers, backboards, chips in plane, chips in free space, etc. In addition, in comparison with the conventional electric interconnection, the optical interconnection has great advantages in communication bandwidth, equal path transmission, electromagnetic interference resistance, low energy consumption, etc.

In the above transmission media for optical interconnection, optical waveguide is widely applied for the optical interconnection within chip, between chip and chip, and between chip modules and backboards. An optical waveguide is composed of a core layer and a cladding layer, wherein light propagates effectively along a light path within the core layer only when the requirement of total internal reflection is met. In other words, in the optical waveguide, only when the core layer material is bigger in refractive index than the cladding layer material, light can be totally reflected, therefore propagating along the designed light path.

Basically, an optical interconnection system includes a semiconductor laser source, a reflecting coupler, a flat optical waveguide (hereinafter referred as optical waveguide) and an optical fiber as an interconnecting medium. Generally, the optical waveguide is at micron level in size. The interconnection between a transmitter and a receiver is established by an optical waveguide and an optical fiber. In view of design factors, such as layouts of backboard and chip, and size of device, the light from the laser usually propagates into the optical fiber with a certain angle instead of in line. FIG. 1 is a schematic diagram of optical interconnection structure with an optical waveguide. As shown in FIG. 1, a light 20 from LASER goes into a flat optical waveguide 10 through a reflecting coupler (end surface 12), the direction of light 20 is changed by the flat optical waveguide 10 and is totally reflected into an optical fiber 30 in a total reflecting mode. The end surface 12 of the optical waveguide 10 is an incline with a required angle, which typically is an angle of 45 degree in order to lead to 90 degree change to the incident light 20. At the same time the end surface 12 of the optical waveguide 10 is designed as a mirror to meet requirement of total internal reflection.

Nowadays, the most popular methods to form the above flat optical waveguide 10 include nanoimprint lithography technology and transfer printing with soft tooling technology. Nanoimprint technology creates a nanoimprint model which is matched to the shape of an optical route within an imprinting mold material on the surface of a substrate such as silicon dioxide (SiO₂) or silicon nitride (SiN) using technologies like lithography, etching, etc. The optical route is then made in the material of core layer on the surface of the optical waveguide by using nanoimprint mold. FIG. 2 to FIG. 5 are schematic diagrams for illustrating the process flow for manufacturing the optical waveguide by using the nanoimprint technology. As shown in FIG. 2, a cladding layer 22 is formed on a substrate 20; then a core layer 24 is formed on the surface of cladding layer 22 as shown in FIG. 3. Subsequently, the core layer 24 is imprinted with a nanoimprint model 30, as shown in FIG. 4, in order to make an optical route 26 as shown in FIG. 5 which is constituted with the core layer material in the core layer 24. FIG. 6 is a tridimensional structure of the optical waveguide in FIG. 5, wherein the direction designated by the arrow is the direction of optical signal propagating. For avoiding the diffuse reflection occurred in the optical route 26, the top surface and side surface of the optical route 26 should be very smooth and uniform. Beside this, it is more important that the incline at the end surface of optical route 26 should be mirror to ensure the total reflection coupling of incident light. It leads to the higher requirement of the technology using nanoimprint model 30 which enhances the cost greatly as the nanoimprint model. In addition, when the design of optical is changed, the model must be changed at the same time to match it, which decreases the agility of the process and increases the cost farther.

Transfer printing with soft tooling technology makes the optical route before it is covered and bonded with the substrate. This technology brings the prolonged manufacturing process and the difficulty for cleaning the residue when the soft tooling is removed from the optical route. Since the mirror surface of soft tooling is limited by the material of optical waveguide itself, the decrease of loss of optical signal intensity when it is reflected is limited correspondingly.

### SUMMARY OF THE INVENTION

The object of the present invention is to provide a wafer level optical waveguide and a method for manufacturing the same, wherein by employing manufacture process for semiconductor integrated circuits, it could be realized to manufacture a micron level optical waveguide with a smooth interface surface, a uniform thickness and a mirror-like end with any angle, and to remarkably reduce manufacturing cost at the meantime.

For achieving the above object, on an aspect, the present invention provides an optical waveguide, comprising a substrate and a restricting layer on said substrate, in which the restricting layer has a groove, the two ends of the groove are inclines, at least the inclines have reflecting surfaces, the said groove comprises a core layer, and the surface of the core layer has a cladding layer.

Preferably, the substrate and the restricting layer are the same layer.

The groove may be formed in the substrate, and the substrate is directly used as the restricting layer.

Preferably, the materials of the substrate can be semiconductor materials and pyrex such as quartz glass, Boron-PhosphoSilicate Glass (BPSG); or organic polymer resins, for example, including but not being limited to polyester resin, polycarbonate resin, phenolic laminated resin, polyurethane resin; or mixtures thereof. In addition, the substrate can also be a PCB board.

The cladding layer comprises a first cladding layer on the upper surface of the core layer, and a second cladding layer on the lower surface of the core layer.

The second cladding is between the substrate and the restricting layer.

The cladding layer is on the upper surface of the core layer, and the lower surface of the core layer is a reflecting mirror layer.

The material of the restricting layer is one selected from the group consisting of silicon, silicon dioxide, silicon nitride, silicon oxynitride, quartz glass and borophosphosilicate glass.

The material of the core layer and the cladding layer is a spin-coating enable macromolecular photosensitive material.

The material of the reflecting mirror layer is metal.

The material of the core layer is positive-photoresist, negative-photoresist, photosensitive polyimide (PSPI), photosensitive sol-gel, or a mixture or combination thereof.

The acute angle between the inclines and the surface of the substrate is from 25 to 75 degree, preferably 45 degree.

Correspondingly, on another aspect, the present invention provides a method for fabricating an optical waveguide, comprising the following steps:

providing a substrate;

forming a restricting layer on the substrate, and forming a groove in the restricting layer, wherein the two ends of the groove are inclines;

at least forming a reflecting mirror layer on the surface of the inclines;

forming at least a core layer in the groove by spin-coating; and

forming a cladding layer on the surface of the core layer by spin-coating.

Preferably, the groove is formed in the substrate, so that the substrate acts as the restricting layer.

The groove is formed by dry etching, mechanical cutting or laser cutting.

The restricting layer is formed by chemical vapor deposition, electrostatic bonding or adhesive bonding technology, etc.

The cladding layer is formed on the upper and lower surfaces of the core layer, or is formed only on the upper surface of the core layer.

The lower surface of the core layer is a reflecting mirror layer when the cladding layer is formed only on the upper surface of the core layer.

The reflecting mirror layer is formed of metal by using physical vapor deposition or electroplating technology.

The cladding layer on the lower surface of the core layer is formed between the substrate and the restricting layer.

On the other aspect, the present invention provides an optical waveguide, comprising a superposed trapeziform structure consisting of a first cladding layer, a core layer and a second cladding layer in order on the surface of a transparent substrate, wherein the two ends of the superposed trapeziform structure are inclines, the surfaces of the inclines have reflecting mirror layers, and the surface of the superposed trapeziform has a semiconductor substrate.

The material of the first cladding layer, the core layer and the second cladding layer are a spin-coating enable macromolecular photosensitive material.

The reflecting mirror layer is made of metal.

The acute angle between the inclines and the surface of the transparent substrate is from 25 degree to 75 degree, preferably 45 degree.

Correspondingly, on another aspect, the present invention provides a method for fabricating an optical waveguide, comprising:

providing a transparent substrate;

forming a first cladding layer material, a core layer material and a second cladding layer material in order on the surface of the transparent substrate by spin-coating, and curing the resulting structure to form a superposed trapeziform structure consisting of a first cladding layer, a core layer and a second cladding layer;

cutting the two ends of the superposed trapeziform structure by using laser to form inclines;

forming a reflecting mirror layer by depositing a metal material onto the surfaces of the incline;

bonding a semiconductor substrate on the surface of the superposed trapeziform structure.

The first cladding layer, the core layer and the second cladding layer are all formed by spin-coating once or several times.

The method further comprises a step of removing the transparent substrate.

As compared with the popular technology in the prior art, the invention brings many advantages:

As for the wafer level optical waveguide and the method for making the same as mentioned in this invention, the integrated circuits (IC) technology instead of the high-cost imprint technology is employed to produce a wafer level optical waveguide. The technology used in the invention is based on the general semiconductor technology and semiconductor equipment. Both the core layer and the cladding layer in the optical waveguide are produced by spin coating a spin-coating enable material which provides the changeable thickness satisfying the different requirements of light path design. The spin-coating enable material is exposed to be solidified and provides a smooth boundary between core layer and cladding layer which aids to decrease the loss according to diffuse reflection during light propagating. The incline of optical waveguide in this invention is made by technologies such as plasma etching, laser incision or mechanical incision which provides end surfaces of the core layer with any angle according to different design. A metal layer is deposited onto the incline to make a total reflecting mirror surface which reduces the loss of the optical signal during optical signal propagation to some extent as low as possible. The method for manufacturing the wafer level optical waveguide according to the invention is simple in process, which decreases the cost and increases the production efficiency. In addition, since the method for manufacturing optical waveguide according to the invention is compatible with the IC technology, it is helpful to perform the optical-electronic integrated manufacture.

### BRIEF DESCRIPTION OF THE DRAWINGS

The above and other objects, features and other advantages of the present invention will be more clearly understood from the following detailed description taken in conjunction with the accompanying drawings (the pictures are not drawn pro rate), in which preferable examples are shown. In all drawings, the same signs refer to the same parts. In the drawings, the thicknesses of layers and regions are amplified for purpose of clarity.

FIG. 1 is a perspective view of a predigested optical interconnection structure with an optical waveguide;

FIG. 2 to FIG. 5 are schematic diagrams of the flow chart to form an optical waveguide using nanoimprint lithography technology;

FIG. 6 is a tridimensional view of the optical waveguide in FIG. 5;

FIG. 7A to FIG. 7G are sectional views of the process flow of the first example of method for forming an optical waveguide in accordance with the invention;

FIG. 7G is a schematic diagram illustrating the structure of the first example of optical waveguide in accordance with the invention;

FIG. 7H is a schematic diagram illustrating the structure of the second example of optical waveguide in accordance with the invention;

FIG. 7I is a schematic diagram illustrating the structure of the third example of optical waveguide in accordance with the invention;

FIG. 7J is a schematic diagram illustrating the structure of the fourth example of optical waveguide in accordance with the invention;

FIG. 8A to FIG. 8H are sectional views of the process flow of the second example of method for forming an optical waveguide in accordance with the invention;

FIG. 8H is a schematic diagram illustrating the structure of the fifth example of optical waveguide in accordance with the invention;

FIG. 8I is a schematic diagram illustrating the structure of the sixth example of optical waveguide in accordance with the invention;

FIG. 9A to FIG. 9D are sectional views of the process flow of the third example of method for forming an optical waveguide in accordance with the invention;

FIG. 9D is a schematic diagram illustrating the structure of the seventh example of optical waveguide in accordance with the invention.

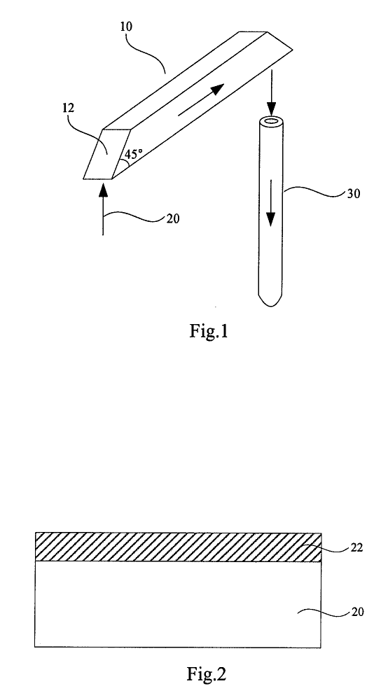

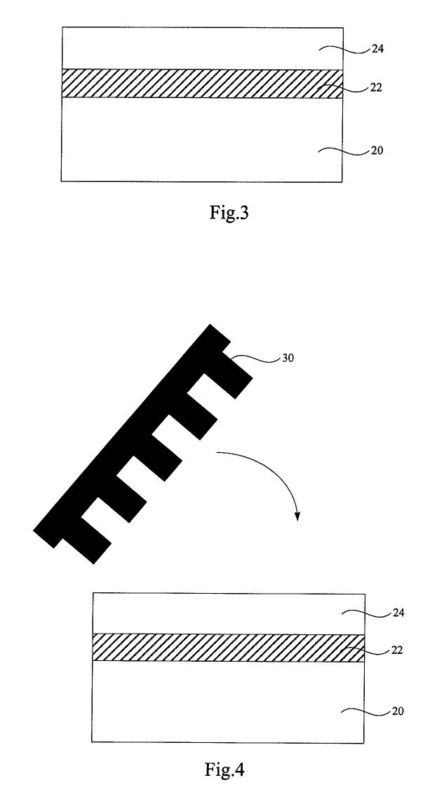

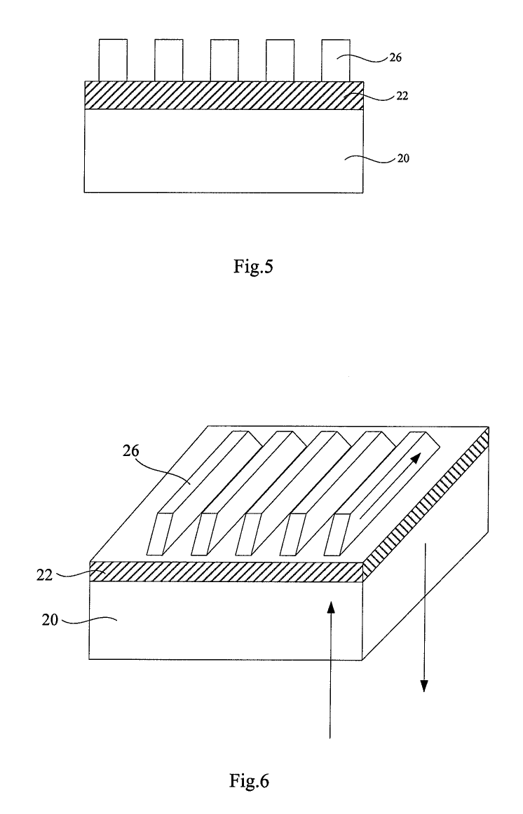

### DESCRIPTION OF THE PREFERRED EMBODIMENTS

The following descriptions illustrate many details for sufficiently understanding the invention. However, the present invention can be carried out by many other manners different from those described herein, and those skilled in the art can make similar extensions without departing the spirit of the present invention. Thus, the present invention is not intended to be restricted by the examples disclosed as follows.

A method for manufacturing an optical waveguide according to the examples of the invention comprises the following steps: firstly providing a substrate; forming a restricting layer on said substrate and forming a groove within the restricting layer, wherein the two ends of said groove are inclines; forming metal layers at least on the said inclines; spin-coating at least a core layer within said groove, and spin-coating a first cladding layer before the core layer is formed by spin-coating, and spin-coating a second cladding layer after the core layer is formed by spin-coating. In other examples, it is possible not to form the first cladding, and to form directly the core layer on the surface of metal layer; in other examples, the groove may be formed in the substrate, and the substrate is directly used as the restricting layer. In order to make the objects, features and advantages of the present invention more easy to be understood, the examples of the present invention are described in detail as follows in conjunction with the drawings.

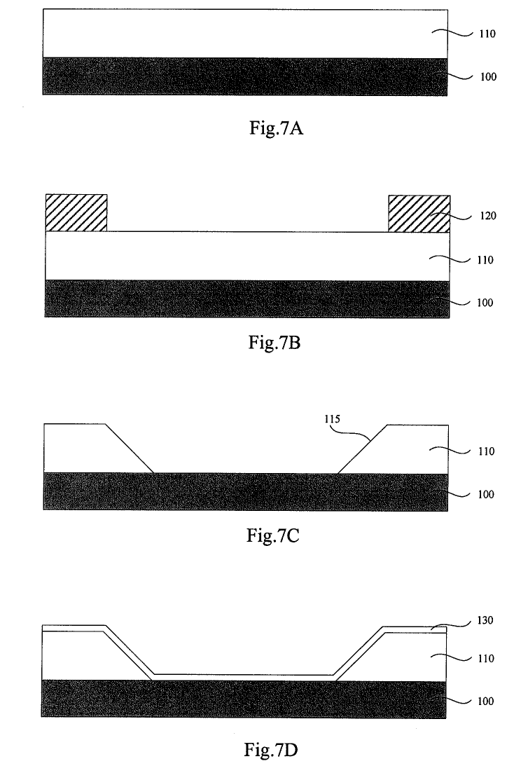

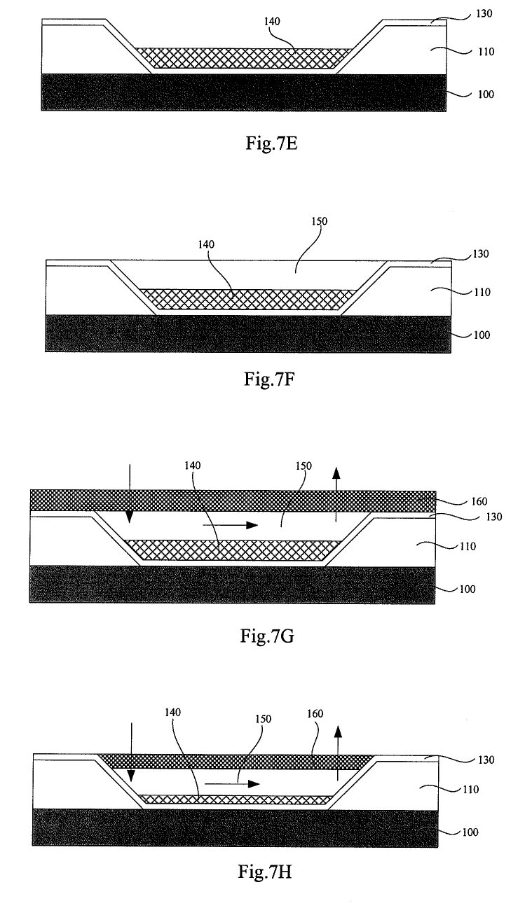

FIG. 7A to FIG. 7G are sectional views of the process flow of the first example of method for making an optical waveguide in accordance with the invention. Firstly, as shown in FIG. 7A, a substrate 100 is provided in the example. The substrate 100 can comprise semiconductor elements, such as silicon or silicon-germanium (SiGe) with monocrystalline, polycrystalline or amorphous structure, also can comprise a mixed semiconductor structure, such as silicon carbide, indium antimonide, lead telluride, indium arsenide, indium phosphide, gallium arsenide or gallium antimonide, semiconductor alloy or combination thereof; and also can be silicon on insulator (SOI). In addition, the substrate 100 may further comprise other materials, such as a multi-layer structure of epilayer or burial layer. Although some examples of materials used as the substrate 100 are described herein, any material used as semiconductor substrate falls within the spirit and the scope of the present invention. The material used as the substrate 100 in the optical waveguide of the present invention is not specifically restricted, and any material which is suitable for supporting polymer can be used as the substrate of the optical waveguide of the present invention. In preferable examples, beside semiconductor materials, the materials used as the substrate can further be pyrex such as quartz glass, Boron-PhosphoSilicate Glass (BPSG); or organic polymer resins, for example, including but not being limited to polyester resin, polycarbonate resin, phenolic laminated resin, polyurethane resin; or mixtures thereof. In addition, the substrate can also be a PCB board.

Then, a material layer 110 is formed on the surface of the said substrate, and the layer 110 is used as a layer for restricting the shape of optical waveguide subsequently formed. The layer 110 is named “restricting layer” hereinafter. The materials for the restricting layer 110 is preferably, but not limited to silicon, glass silicon dioxide (SiO₂), for example, it also can be silicon nitride, silicon oxynitride, quartz glass or BPSG, etc. The layer 110 can be formed by chemical vapor deposition or by an electrostatic bonding method to connect glass and silicon wafer together. In addition, the restricting layer 110 and the substrate 100 can be bonded together using a binding agent such as epoxy resin. The layer 110 also can be formed by a spin coating method using a spin-coating enable glass, such as the spin-coating enable silicon oxide (Applied Materials, Inc.), which has a trademark of “black diamond” (BD). The restricting layer is then cut into a geometry size with desired length, width, height, etc. according to the requirement of designed size of the optical waveguide.

In other examples of the present invention, the substrate can be directly used as the restricting layer, i.e., directly forming a groove within the substrate using methods such as etching, mechanically cutting or laser cutting methods.

In the following steps, as shown in FIG. 7B, a photoresist pattern 120 is formed by coating a photoresist on the surface of the restricting layer 110, then exposing, developing and baking etc to pattern the photoresist, and is used as a mask for etching the restricting layer 110. Then, the restricting layer 110 is etched by using the photoresist pattern 120 as mask to form a groove with inclines at its two sides within the layer 110, as shown in FIG. 7C. All suitable dry-etching methods, such as reaction ion etch (RIE) can be used to etch the above restricting layer 110. During etching, the etching direction is controlled by adjusting the bias power of plasma source or bias power of cathode (i.e., the substrate). The gas used in the etching includes fluorine-containing gases, such as CF₄, C₂F₆ and CHF₃, and inert gases such as Ar. All the gases are fed into the reaction chamber simultaneously, wherein Ar is used for diluting the etching gas and has a flux ranging from 50 sccm to 400 sccm; in the etching gases, the flux of CF₄ is 10 sccm-100 sccm, the flux of C₂F₆ is 10 sccm-400 sccm, and the flux of CHF₃ is 10 sccm-100 sccm. The gases are ionized into plasma in the reaction chamber with a radio frequency power source having 50 W-1000 W radio power and a ratio bias power source having 50 W-250 W radio frequency bias power. The pressure in the reaction chamber is 50 mTorr-200 mTorr, and the temperature of the substrate 100 is controlled between 20° C. and 90° C. The aforementioned plasma etching process is an anisotropic etching process, wherein the inclines 115 of the groove are formed by the co-action of etching gas and diluting inert gas within the restricting layer 110 after the etching, and the angle of the inclines 115 ranges from 25 degree to 75 degree, preferably 45 degree in the present example.

In other examples, inclines 115 with different desired angles can be formed by using laser cutting technology or mechanically cutting technology.

The surface of the etched restricting layer 110 is cleaned to remove residues and micro particles after etching.

Then, as shown in FIG. 7D, a metal layer 130 is deposited on the surface of the etched restricting layer 110 to enhance light reflection effect. The metal layer 130 can be formed by physical vapor deposition (PVD) or electroplating. The material of the metal layer 130 is preferably, but not limited to metals such as gold, silver, aluminum, chrome, etc., and the thickness of the metal layer 130 is 1-5 μm.

In other examples of the present invention, the metal layer 130 on the surface of the restricting layer 110 can be removed by chemical mechanical grind or chemical etching process, and then the surface is cleaned.

Subsequently, as shown in FIG. 7E, a lower cladding layer 140 is formed on the bottom surface of the groove by spin-coating. The material of this layer can be all suitable spin-coating enable materials known to those skilled in the art, including but not limited to, such as polyacrylate, polysiloxane, polyimide, polycarbonate and other macromolecular photosensitive polymers, such as Bottom anti-reflective coatings (BARCs) and silicon-rich polymer well known to those skilled in the art such as a series of products with GF as trademark (Brewer Science Inc.), or a mixture solution of methacryl-oxypropyltriethoxysilane (MPETS) and phenyltriethoxysilane (PhTES).

Then, the lower cladding layer 140 is cured. The method for curing the lower cladding layer 140 is not specially limited, and are those well known by those skilled in the art, including by not being limited to such as light curing or thermal curing, and in preferable examples, the curing is performed with the irradiation of an unpolarized light. Basically, the unpolarized light refers to a light with certain range wave length such as ultraviolet ray, infrared ray or heat ray with no limitation of oscillation direction of electronic field, preferably ultraviolet ray.

In the next step, as shown in FIG. 7F, a core layer 150 is formed on the lower cladding layer 140 by spin-coating a core layer material and exposing with ultraviolet ray. According to the requirement of the thickness of the core layer, the core layer 150 and the metal layer 130 are at the same level. In other examples of the present invention, the surface of the core layer 150 can be lower than the surface of the metal layer 130. The core layer material is a photosensitive macromolecular material without photoinitiator, therefore, this material must be able to absorb light energy and change into its exciting state under the irradiation of a polarized light with a certain wavelength in order to induce a directional chain reaction thereby changing its refractive index. The wavelength of the polarized light used in this invention depends on the photosensitive material used. The appropriate photosensitive material includes but not limited to a variety of photoresists (including positive photoresists and negative photoresists), photosensitive polyimide resin (PSPI), photosensitive-type sol-gel or a mixture or combination thereof, as well as PhTES, N-methyl-2-pyrrolidone (NMP), poly(methyl methacrylate) (PMMA) or a mixture solution thereof.

Then, an upper cladding layer 160 is spin-coated on the core layer 150, and then formed by lithography and etching, as shown in FIG. 7G. The material for this layer is identical to that for the lower cladding layer 140, and can be any kind of suitable spin-coating enable material known by those skilled in the art, including but not being limited to such as polyacrylate, polysiloxane, polyimide or polycarbonate, as well as other photosensitive macromolecular materials such as Bottom anti-reflective coatings (BARCs) and silicon-rich polymer, etc. When the upper cladding layer and the core layer of optical waveguide are formed of photosensitive resins, the refractive index of the resins is stable. At other example of the present invention, the refractive index of the resins will change according to the light exposure of ultraviolet ray during the curing. The light exposure of ultraviolet ray should be controlled precisely. When the upper cladding layer 160 and the lower cladding layer 140 are cured, the central wavelength of ultraviolet ray is 365 nm, the light intensity of ultraviolet ray is 200 W/cm², the distance between the layers and the ultraviolet light source is 10 mm, and the time of exposure is about 30 minutes. After the core layer 150 is spin-coated, it should be exposed and developed for making a structure like optical waveguide, i.e., an optical path. The part which is developed is filled with the upper cladding layer 160 to form a complete three-dimensional optical path. When the core layer 150 is cured, the central wavelength of ultraviolet ray is 650 nm, the light intensity of ultraviolet ray is 100 W/cm², the distance between the core layer 150 and the ultraviolet light source is 10 mm, and the time of exposure is about 30 minutes.

FIG. 7G is a schematic diagram illustrating the structure of the first example of optical waveguide of the present invention. As shown in FIG. 7G, the arrow indicates the optical propagating route. The optical waveguide in the first example of optical waveguide of the present invention comprises a restricting layer 110 formed on the surface of the substrate, a groove which is formed within the restricting layer 110 and has two inclines at the two ends of said groove, a metal layer 130 at least covering the surfaces of the bottom and the surface of the inclines in order to increase the reflectivity of incident light. The groove in the restricting layer 110 comprises at least a lower cladding layer 140, a core layer 150 and an upper cladding layer 160, which are stacked in the groove in order, wherein the upper cladding layer 160 covers the surfaces of the core layer 150 and the restricting layer 110, and wherein the refractive index of the core layer 150 is far greater than the refractive index of the lower cladding layer 140 and the upper cladding layer 160. The lower cladding layer 140, the core layer 150 and the upper cladding layer 160 are all formed by spin-coating processes using spin-coating enable materials, so that the obtained layers have very smooth surfaces and excellent uniformity in thickness.

FIG. 7H is a schematic diagram illustrating the structure of the second example of optical waveguide in accordance with the present invention. As shown in FIG. 7H, the arrow indicates the optical propagating route. As compared to the optical waveguide of the first example, the optical waveguide of the second example of optical waveguide comprises a superposed structure comprising a lower cladding layer 140, a core layer 150 and a upper cladding layer 160, wherein the superposed structure is restricted within the groove, so that the lower cladding layer 140, the core layer 150 and the upper cladding layer 160 have more uniform consistency in thickness.

FIG. 7I is a schematic diagram illustrating the structure of the third example of optical waveguide in accordance with the present invention; and FIG. 7J is also a schematic diagram illustrating the structure of the fourth example of optical waveguide in accordance with the present invention. The arrows show the optical signal propagating route. As shown in FIG. 7I and FIG. 7J, no lower cladding layer is formed by the above process, but a core layer 150 is directly spin-coated in the groove, and then an upper cladding layer 160 is formed on the core layer 150, thereby forming the structures as shown in FIG. 7I and FIG. 7J.

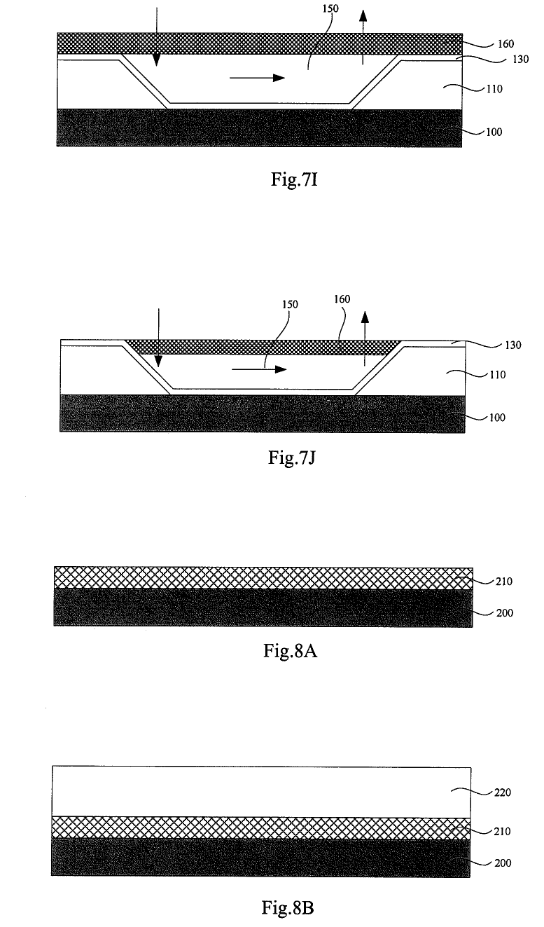

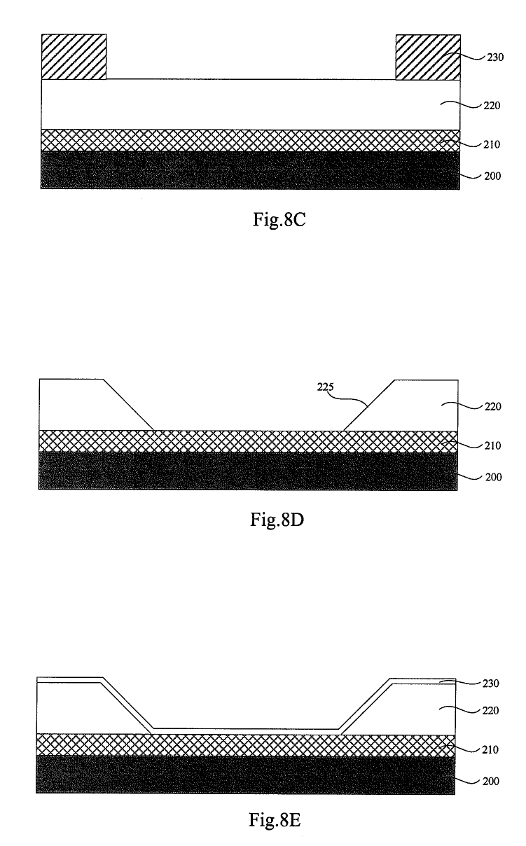

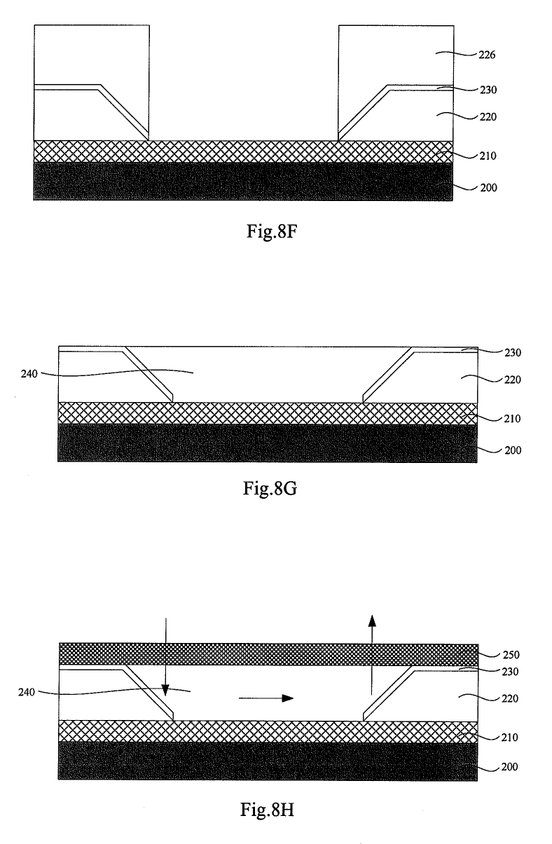

FIG. 8A to FIG. 8H are sectional views showing the process flow of the second example of method for making an optical waveguide in accordance with the invention. Firstly, as shown in FIG. 8A, a substrate 200 is provided, which is identical to that in the first example of method for making optical waveguide of the present invention. Besides semiconductor materials, the materials used as the substrate 200 in the optical waveguide of the present invention is not specifically limited, and any material which is suitable for supporting a polymer can be used as the substrate of the optical guideline of the present invention. In preferable examples, beside semiconductor material, the materials used as the substrate can be pyrex such as quartz glass and Boron-PhosphoSilicate Glass (BPSG); or organic polymer resin including but not being limited to such as polyester resin, polycarbonate resin, phenolic laminated resin, or polyurethane resin; or mixtures thereof.

A photosensitive macromolecular polymer, such as polyacrylate, polysiloxane, polyimide, polycarbonate and so on, is then spin-coated onto the surface of the substrate 200 to form a lower cladding layer 210.

Then, as shown in FIG. 8B, a restricting layer 220 is formed on the surface of said lower cladding layer 210 by a technology such as CVD, electrostatic bonding or adhesive bonding technology, etc. A photoresist mask pattern 230 is formed on said restricting layer 220 by lithography, as shown in FIG. 8C. The restricting layer 220 is etched by using photoresist mask pattern 230 to form a groove in the restricting layer 220 with inclines 225 formed at the two ends of said groove by plasma etching. In other examples, a groove with inclines 225 at its two ends also can be formed by laser cutting. The angle of the inclines 225 is from 25 degree to 75 degree, and is preferably 45 degree in this example, as shown in FIG. 8D.

Then, a metal layer 230 is deposited on the surfaces of the etched restricting layer 220 and the lower cladding layer 210 to increase the refractivity, as shown in FIG. 8E. In other examples of the present invention, the metal layer on the restricting layer 220 is removed by grinding or other methods. Subsequently, as shown in FIG. 8F, a photoresist pattern 226 is preferably formed in the example in order to expose the metal layer 230 on the surface of the lower cladding 210 on the bottom of the groove and to etch the exposed metal layer 230 by plasma etching or RIE process, wherein the etchant is a gas containing chlorine or bromine. Then the photoresist pattern 226 is removed, and the residues and micro particles left by etching on the surface of the lower cladding layer 210 and the metal layer 230 were cleaned to ensure that there is no impurity on the boundary between the core layer and the cladding layer 210 or the metal layer 230.

In the next step, a core layer 240 is formed by spin-coating a core layer material in the groove, as shown in FIG. 8G. The core layer material is a photosensitive-type macromolecular material without photoinitiator, therefore, this material should be able to absorb light energy and change into its exciting state under the irradiation of a polarized light with a certain wavelength in order to induce a directional chain reaction thereby changing its refractive rate. The wavelength of the polarized light used in this invention depends on the photosensitive material. The suitable photosensitive material includes but not limited to a variety of photoresists (including positive photoresists and negative photoresists), photosensitive-type polyimide resin (PSPI), photosensitive-type sol-gel or a mixture or combination thereof, as well as PhTES, N-methyl-2-pyrrolidone (NMP), poly(methyl methacrylate) (PMMA) or a mixture solution thereof. The core layer 240 is formed in the whole groove, as shown in FIG. 8G. The upper surface of the core layer 240 and the surface of the layer 230 are level. An upper cladding layer 250 is formed by spin-coating a photosensitive macromolecular polymer, such as polyacrylate, polysiloxane, polyimide, polycarbonate, and so on, on the core layer 240 and curing by using ultraviolet radiation, as shown in FIG. 8H.

FIG. 8H is also a schematic diagram illustrating the structure of the fifth example of optical waveguide according to the present invention. In the optical waveguide structure as shown in FIG. 8H, the arrow indicates the optical signal propagating route. The lower cladding layer 210, the core layer 240 and the upper cladding layer 250 constitute a superposed structure, wherein the refractive index of the core layer 240 is far greater than the refractive index of the lower cladding layer 210 and the upper cladding layer 250. Since the core layer 240 is totally in the groove, the reflecting area of mirror surface is larger and the effect of total reflection is better. The boundaries among the lower cladding layer 210, the core layer 240 and the upper cladding layer 250 are more smooth and straighter.

FIG. 8I is a schematic diagram illustrating the structure of the sixth example of optical waveguide according to the present invention, wherein the arrow shows the optical signal propagating route. In this example, the metal reflecting layer on the bottom of the groove is retained.

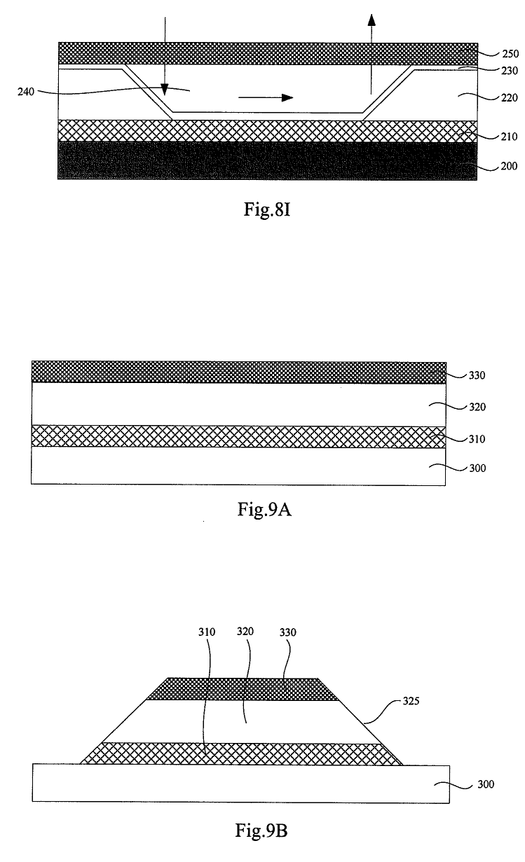

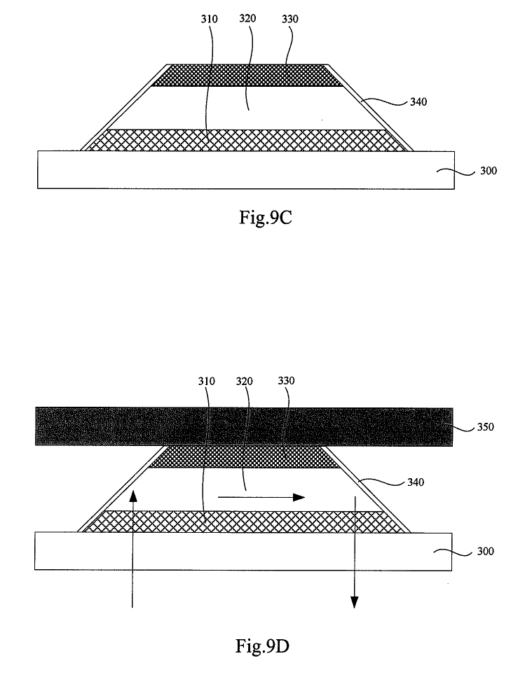

FIG. 9A to FIG. 9D are sectional views of the process flow of the third example of method for forming an optical waveguide according to the present invention. Firstly, as shown in FIG. 9A, on the surface of a substrate 300 of a transparent material, such as glass and quartz, a layer of lower cladding layer material, a layer of coring layer material and a layer of upper cladding layer material are spin-coated in order, and are cured by using ultraviolet radiation to form a lower cladding layer 310, a core layer 320 and an upper cladding layer 330 in order. The materials used for the lower cladding layer 310, the core layer 320 and the upper layer 330 are identical to those used in the above examples, so that they are not unnecessarily described herein.

Then, as shown in FIG. 9B, the two sides of the superposed structure formed of the lower cladding layer 310, the core layer 320 and the upper cladding layer 330 are cut by plasma etching, preferably laser cutting or mechanical cutting to form inclines 325 with a certain angle, preferably a 45 degree angle in this example.

Subsequently, a metal layer 340 is deposited or electroplated on the surface of the inclines 325 to increase reflectivity, wherein the material of the metal layer 340 is identical to that of the aforementioned metal layer, as shown in FIG. 9C. Then, as shown in FIG. 9D, the superposed trapeziform structure, which is formed of the lower cladding layer 310, the core layer 320 and the upper cladding layer 330 and has the metal layer 340 on the side surfaces of the structure, is bonded on the substrate 350 that is made of silicon or other semiconductor materials.

FIG. 9D is also a schematic diagram illustrating the structure of the seventh example of optical waveguide according to the present invention, wherein the arrow shows the optical signal propagating route. In FIG. 9D, all of the lower cladding layer 310, the core layer 320 and the upper cladding layer 330 in the optical waveguide structure are spin-coated on the substrate, and there is not a restricting layer with a groove as other examples, so that the boundaries among the lower cladding layer 310, the core layer 320 and the upper cladding layer 330 are more smooth and straighter.

The semiconductor material substrate 350, the optical waveguide layer including the lower cladding layer 310, the core layer 320 and the upper cladding layer 330, and the substrate 300 together form a sandwich structure. Since the substrate 300 is of glass, the optical signal may be transmitted through the glass. In other examples of the present invention, if the loss caused by the transmission through the substrate 300 is to be reduced, the transparent substrate 300 can be removed by grinding as needed.

It should be understood that in all examples of the present invention, each of the lower cladding layer, core layer and upper cladding layer can be formed by spin-coating once or several times to achieve the required precise thickness. The angle of inclines is the acute angle between the incline and the surface of the substrate.

All above examples are preferred examples and are not intended to restrict the present invention in any way. Although the present invention has been described hereinabove in its preferred form with a certain degree of particularity, many other changes, variations, combinations and sub-combinations are possible therein. It is therefore to be understood by those of ordinary skill in the art that any modifications will be practiced otherwise than as specifically described herein without departing from the scope and spirit of the present invention.

What is claimed is:

1. An optical waveguide, comprising a superposed trapeziform structure consisting of a first cladding layer, a core layer and a second cladding layer in order on the surface of a transparent substrate, wherein the two ends of the superposed trapeziform structure are inclines, the surfaces of the inclines have reflecting mirror layers, and the surface of the superposed trapeziform has a semiconductor substrate.

2. An optical waveguide according to claim 1, wherein the material of the first cladding layer, the core layer and the second cladding layer are a spin-coating enable macromolecular photosensitive material.

3. An optical waveguide according to claim 1, wherein the material of said reflecting mirror layer is metal.

4. An optical waveguide according to claim 1, wherein an acute angle between the inclines and the surface of the transparent substrate is 45 degree.

5. A method for fabricating an optical waveguide as claimed in claim 1, comprising:
providing a transparent substrate;
forming a first cladding layer material, a core layer material and a second cladding layer material in order on the surface of the transparent substrate by spin-coating, and curing the resulting structure to form a superposed trapeziform structure consisting of a first cladding layer, a core layer and a second cladding layer;
cutting the two ends of the superposed trapeziform structure by using laser to form inclines;
forming a reflecting mirror layer by depositing a metal onto the surfaces of the inclines;
bonding a semiconductor substrate on the surface of the superposed trapeziform structure.

6. A method according to claim 5, wherein the first cladding layer, the core layer and the second cladding layer are all formed by spin-coating once or several times.

7. A method according to claim 5, wherein the method further comprises a step of removing the transparent substrate.
